(19) United States
(12) Patent Application Publication
(10) Pub. No.: US 2021/0125103 A1
(43) Pub. Date: Apr. 29, 2021

(54) COMPUTER SYSTEM, LEARNING METHOD, AND PROGRAM

(71) Applicant: Hitachi, Ltd., Tokyo (JP)

(72) Inventors: Yuichiro AOKI, Tokyo (JP); Yuki KONDO, Tokyo (JP); Yoshiki KUROKAWA, Tokyo (JP)

(21) Appl. No.: 17/071,025

(22) Filed: Oct. 15, 2020

(30) Foreign Application Priority Data
Oct. 23, 2019 (JP) 2019-192475

(51) Int. Cl. G06N 20/00; G06K 9/62; G06F 11/34

(52) U.S. Cl. CPC G06N 20/00; G06F 11/3409; G06K 9/6227; G06K 9/6256

(57) ABSTRACT

A computer system executing a learning process for generating a model includes: a computer having calculation cores; and a learning section. The learning section acquires performance information indicating performance characteristics of the calculation cores executing a positive sample calculation and the calculation cores executing a negative sample calculation, computes a maximum value of the number of negative samples in the negative sample calculation on the basis of the performance information, determines the number of the negative samples based on the maximum value, and generates the model by causing at least one of the calculation cores to execute the positive sample calculation using a predetermined number of pieces of training data to serve as positive samples in the training data, and by causing at least one of the calculation cores to execute the negative sample calculation using the determined number of the negative samples randomly selected from the training data.

### CLAIM OF PRIORITY

The present application claims priority from Japanese patent application JP 2019-192475 filed on Oct. 23, 2019, the content of which is hereby incorporated by reference into this application.

### BACKGROUND OF THE INVENTION

### 1. Field of the Invention

The present invention relates to a learning process for generating a model such as a neural network model.

### 2. Description of the Related Art

In recent years, machine learning using neural networks has been used widely. Among types of machine learning, multi-class classification problems are used often in handwritten digit recognition, facial image identification, natural language processing and the like. Multi-class classification problems are problems related to classification of input data into any of a plurality of classes. For example, in handwritten digit recognition, ten types of handwritten digits from 0 to 9 are classified into correct digits.

The methods that are used for classifying them fast by using neural networks are negative sampling methods (negative sampling methods). In a negative sampling method, a probability of accuracy P(xₜ) is computed by using Formulae (1) and (2). Here, xₜ is input data, V_{ng} is a set of data different from the input data xₜ, x_{ng} is elements in the set V_{ng}, and σ(x) is a sigmoid function.

$$\begin{matrix}[ Formula 1 ] & \\ P ( {x}_{t} ) = σ ( {x}_{t} ) {\prod }_{{x}_{ng} ∈ {V}_{ng}} ( 1 - σ ( {x}_{ng} ) ) & ( 1 ) \\ [ Formula 2 ] & \\ σ ( x ) = \frac{1}{1 + {e}^{- x}} & ( 2 )\end{matrix}$$

This method attempts to represent the probability of accuracy P(xₜ) by obtaining the product of a contribution σ(xₜ) of the input data xₜ to the probability of accuracy, and a contribution 1−σ(x_{ng}) of x_{ng}, which is data other than the input data xₜ, to the probability of accuracy. Here, xₜ is referred to as a positive sample (positive sample), x_{ng} is referred to as a negative sample (negative sample).

It is empirically known that even in a case where there is a very large number of pieces of data (e.g. in a case where the number of pieces of data is in the range of 10⁵ to 10⁷), there have to be only a small number of negative samples. For example, “Mikolov, Tomas, et al., “Distributed representations of words and phrases and their compositionality,” In the Proceedings of the Advances in Neural Information Processing Systems, 2013” states that there have to be only several to several dozen negative samples. In addition, negative samples may be selected randomly from input data other than positive samples.

A parallel processing of negative sampling using a graphics processing unit (GPU), a field programmable gate array (FPGA) or the like has also been proposed for further increasing speed. For natural language processing like word2vec using a negative sampling method, parallel processing methods like the one (HogWild parallel processing) described in “Recht, Benjamin, et al., “Hogwild: A lock-free approach to parallelizing stochastic gradient descent,” In the Proceedings of the Advances in Neural Information Processing Systems, 2011” have been proposed.

The HogWild parallel processing is a technique for parallel execution of the loop in the first line of the following loop nest without implementing synchronization. Not implementing synchronization processing gives the advantage of enabling fast execution.

| | |
|---|---|
| 01: | for (int d=0; d<M; d++) { |

| | |
|---|---|
| 02: | L=...; |
| 03: | for (int i=0; i<N; i++) { b[i] += a[i+L]; } |
| 04: | for (int i=0; i<N; i++) { a[i+L] += ...; } |

| | |
|---|---|
| 05: | } |

However, in the HogWild parallel processing according to “Gupta, Saurabh, and Vineet Khare, “Blazingtext: Scaling and accelerating word2vec using multiple gpus,” Proceedings of the Machine Learning on HPC Environments, 2017,” parallelization is implemented ignoring the relationship of dependence between variables (in the example described above, the relationship between the reading in the second line from an array element a[i+L] and the reading in the third line from the array element a[i+L]. Accordingly, in the example described above, in a case where a variable L in the second line becomes the same value for different values of a loop control variable d in the first line (equivalent to the time of execution of a positive sample calculation process), there is a possibility that, in the loops of the third and fourth lines, a phenomenon occurs in which the execution order of the reading from a memory (a[i+L] in the third line) and the writing into the memory (a[i+L] in the fourth line) is reversed, and a[i+L] in the third line uses a value before the update of the value of a[i+L] in the fourth line. It has been pointed out that, as a result, there is a fear that the accuracy of inference results of a generated model deteriorates. Note that it has been known that since the value of L is determined randomly at the execution time of a negative sample calculation process, such a phenomenon hardly occurs.

In order to avoid situations like the one described above, in possible process methods, a positive sample calculation is performed as sequential processing, a negative sample calculation is performed, in contrast, as a parallel processing, and the parallel processing are offloaded to an accelerator having a GPU, a FPGA or the like mounted thereon.

Although there is a rule of thumb applied at this time that there have to be only several to several dozen negative samples, there are no known methods for uniquely determining the number of negative samples.

As described in “Mikolov, Tomas, et al., “Distributed representations of words and phrases and their compositionality,” In the Proceedings of the Advances in Neural Information Processing Systems, 2013,” since there is a positive correlation between the number of negative samples and the inference accuracy, the inference accuracy improves if a very large number of negative samples is used. However, if the number of negative samples increases, the execution time of calculation processes increases (equivalent to an increase in the number of elements in V_{ng} in Formula (1)), and the execution time required for the learning process itself increases also.

Accordingly, in conventional techniques, there is no way but to generate a plurality of models by adjusting the number of negative samples over and over again by trial and error, and find a number of negative samples that maximizes the inference accuracy in an allowed length of processing time. Since this involves a lot of repetition of generation of models, the computation naturally takes a long time.

The present invention provides a system and a method that make it possible to uniquely determine the number of negative samples that can reduce the length of time required for learning processes in learning of neural networks using negative sampling methods to be in a practical range, and can generate a model with high inference accuracy.

### SUMMARY OF THE INVENTION

One representative example of the invention disclosed in this application is as follows. That is, a computer system that executes a learning process for generating a model for event prediction by using a negative sampling method includes: at least one computer having a plurality of calculation cores and a storage apparatus; and a learning section that executes the learning process by using a plurality of pieces of training data. In the computer system, the learning section acquires performance information indicating performance characteristics of the calculation cores that execute a positive sample calculation, and the calculation cores that execute a negative sample calculation, computes a maximum value of the number of negative samples in the negative sample calculation on the basis of the performance information, determines the number of the negative samples on the basis of the maximum value, and generates the model by causing at least one of the calculation cores to execute the positive sample calculation using a predetermined number of pieces of training data to serve as positive samples in the training data, and by causing at least one of the calculation cores to execute the negative sample calculation using the determined number of the negative samples randomly selected from the training data.

According to the present invention, in a computation method for neural networks using negative sampling methods that uses a negative sampling method, it is possible to uniquely determine the number of negative samples that can reduce the length of time required for learning processes to be in a practical range, and can generate a model with high inference accuracy. Problems, configurations and effects other than those described above are made apparent through the following explanation of embodiments.

### BRIEF DESCRIPTION OF THE DRAWINGS

FIG. 1 is a figure illustrating one example of a configuration of a computer system in a first embodiment;

FIG. 2 is a figure illustrating one example of a hardware configuration of an accelerator in the first embodiment;

FIG. 3 is a figure illustrating one example of a structure of a neural network generated by the computer system in the first embodiment;

FIG. 4 is a flowchart for explaining one example of a learning process executed by a computer in the first embodiment;

FIG. 5 is a flowchart for explaining one example of a number-of-negative-samples computation process executed by a neural network learning section in the first embodiment;

FIG. 6 is a figure illustrating one example of a configuration file in the first embodiment;

FIG. 7 is a flowchart for explaining one example of an array initialization process executed by the neural network learning section in the first embodiment;

FIG. 8 is a flowchart for explaining one example of a CPU transmission process executed by the neural network learning section in the first embodiment;

FIG. 9 is a flowchart for explaining one example of a thread generation process executed by the neural network learning section in the first embodiment;

FIG. 10A is a figure for explaining a compilation process executed by the neural network learning section in the first embodiment;

FIG. 10B is a figure for explaining the compilation process executed by the neural network learning section in the first embodiment;

FIG. 11 is a flowchart for explaining one example of a positive sample calculation process executed by a CPU in the first embodiment;

FIG. 12 is a flowchart for explaining one example of an accelerator process executed by the accelerator in the first embodiment;

FIG. 13 is a flowchart for explaining one example of an accelerator reception process executed by the accelerator in the first embodiment;

FIG. 14 is a flowchart for explaining one example of a negative sample calculation process executed by the accelerator in the first embodiment;

FIG. 15 is a flowchart for explaining one example of a negative sample main process executed by the accelerator in the first embodiment;

FIG. 16 is a flowchart for explaining one example of an accelerator transmission process executed by the accelerator in the first embodiment;

FIG. 17 is a flowchart for explaining one example of a CPU reception process executed by the neural network learning section in the first embodiment;

FIG. 18 is a flowchart for explaining one example of an array addition process executed by the neural network learning section in the first embodiment;

FIG. 19 is a figure illustrating one example of a hardware configuration of the accelerator in a second embodiment;

FIG. 20 is a figure illustrating one example of a configuration file in the second embodiment;

FIG. 21 is a figure for explaining a compilation process executed by a neural network learning section in the second embodiment;

FIG. 22 is a flowchart for explaining one example of the negative sample calculation process executed by the accelerator in the first embodiment;

FIG. 23 is a flowchart for explaining one example of a pipeline process executed by the accelerator in the second embodiment;

FIG. 24 is a figure illustrating one example of a configuration file in a third embodiment; and

FIG. 25 is a figure for explaining a compilation process executed by a neural network learning section in the third embodiment.

### DESCRIPTION OF THE PREFERRED EMBODIMENTS

In the following, embodiments of the present invention are explained by using the drawings. It should be noted however that the interpretation of the present invention should not be limited to the contents of description of the embodiments illustrated below. Those skilled in the art easily understand that specific configurations of the present invention may be modified within the scope not deviating from the idea and gist of the present invention.

In the configuration of the invention explained below, identical or similar configurations or functionalities are given identical reference characters, and overlapping explanation is omitted.

The notation using “first,” “second,” “third” and the like in this specification and the like is for identifying constituent elements, and does not necessarily limit numbers or orders.

In the following, Linux (Linux is a registered trademark; the same applies hereinafter) is used as the operating system (OS). Regarding programming languages, C is used as the programming language for CPUs, and the Open Computing Language (OpenCL; OpenCL is a registered trademark; the same applies hereinafter) is used as the programming language for GPUs, the programming language for FPGAs and the programming language for multi-core CPUs. However, the scope of the present invention is not limited to the OS and the description languages, but the present invention can be applied also to other OSs such as Windows (Windows is a registered trademark; the same applies hereinafter), and languages for accelerators other than OpenCL, hardware description languages such as Verilog HDL or VHDL, and the like.

### First Embodiment

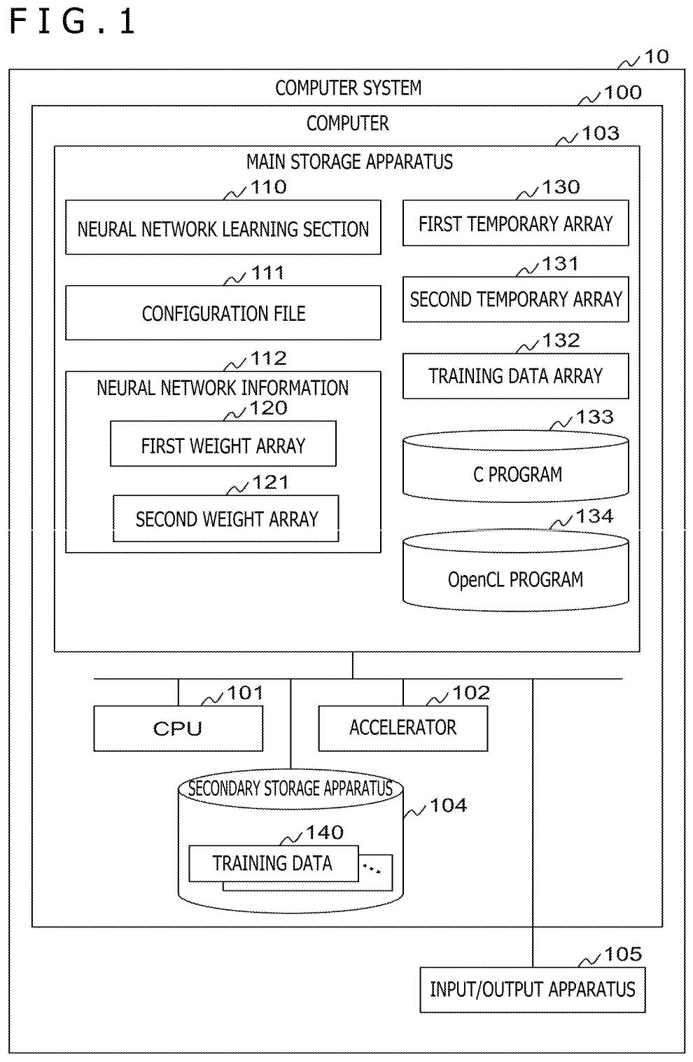

FIG. 1 is a figure illustrating one example of a configuration of a computer system in a first embodiment.

A computer system 10 includes at least one computer 100. In a case where the computer system 10 includes a plurality of computers 100, the computers 100 are connected with each other via a network such as a local area network (LAN) or a wide area network (WAN). Note that a method used for the connection may be any of wired connection methods and wireless connection methods.

The computer 100 includes a central processing unit (CPU) 101, an accelerator 102, a main storage apparatus 103 and a secondary storage apparatus 104. In addition, the computer 100 is connected with an input/output apparatus 105.

The CPU 101 and the accelerator 102 are calculating apparatuses that have at least one calculation core, and execute a calculation process according to a program. The CPU 101 executes a calculation process for controlling the entire computer 100, and a calculation process for generating a neural network 300 (refer to FIG. 3). In cooperation with the CPU 101, the accelerator 102 executes a calculation process for generating the neural network 300. For example, the accelerator 102 is a board having a GPU, a FPGA or the like mounted thereon, a multi-core CPU or the like. It is assumed in the first embodiment that the accelerator 102 is a GPU-mounted board.

The main storage apparatus 103 is a storage apparatus that stores a program, and data used by the program. The main storage apparatus 103 is used also to keep a work area for the program to temporarily use. For example, the main storage apparatus 103 is a memory such as a dynamic random access memory (DRAM). The program and the data stored on the main storage apparatus 103 are mentioned below.

The secondary storage apparatus 104 is a storage apparatus that has a large storage-area capacity, and stores data permanently. For example, the secondary storage apparatus 104 is a hard disk drive (HDD), a solid state drive (SSD) or the like. The data stored on the secondary storage apparatus 104 is mentioned below.

The input/output apparatus 105 is an apparatus through which input of information to the computer 100, and output of information from the computer 100 are performed. For example, the input/output apparatus 105 is a keyboard, a mouse, a touch panel, a display and the like.

Here, the programs and the data stored on the main storage apparatus 103 and the secondary storage apparatus 104 are explained.

The secondary storage apparatus 104 stores training data 140 used for a learning process. The training data 140 may be data including only input data, or may be data including a pair of input data and teaching data.

The main storage apparatus 103 stores a program that realizes a neural network learning section 110, stores a program that realizes a positive sample calculation process (C program 133), and a program that realizes a negative sample calculation process (OpenCL program 134), and stores a configuration file 111 and a neural network information 112. In addition, the main storage apparatus 103 stores a first temporary array 130, a second temporary array 131 and a training data array 132 that are to be used in the learning process.

Note that the C program 133 and the OpenCL program 134 may be included in the program that realizes the neural network learning section 110. In addition, the program that realizes the neural network learning section 110 includes a compiler for compiling a program used in the learning process.

The neural network learning section 110 is a functional section (module) realized by the CPU 101 executing the program. The neural network learning section 110 executes the learning process for generating the neural network 300.

The neural network information 112 stores information of the neural network 300 generated by the learning process. The neural network information 112 includes a first weight array 120 and a second weight array 121 that are information related to weights of edges connecting layers.

Note that the program and the data stored on the main storage apparatus 103 may be stored on the secondary storage apparatus 104. In this case, the CPU 101 reads out the program and the data from the main storage apparatus 103, and loads the program and the data onto the main storage apparatus 103.

Note that in a case where the computer system 10 includes a plurality of computers 100, functional sections and information may be placed such that the functional sections and the information are distributed among the plurality of computers 100.

FIG. 1 has been explained thus far.

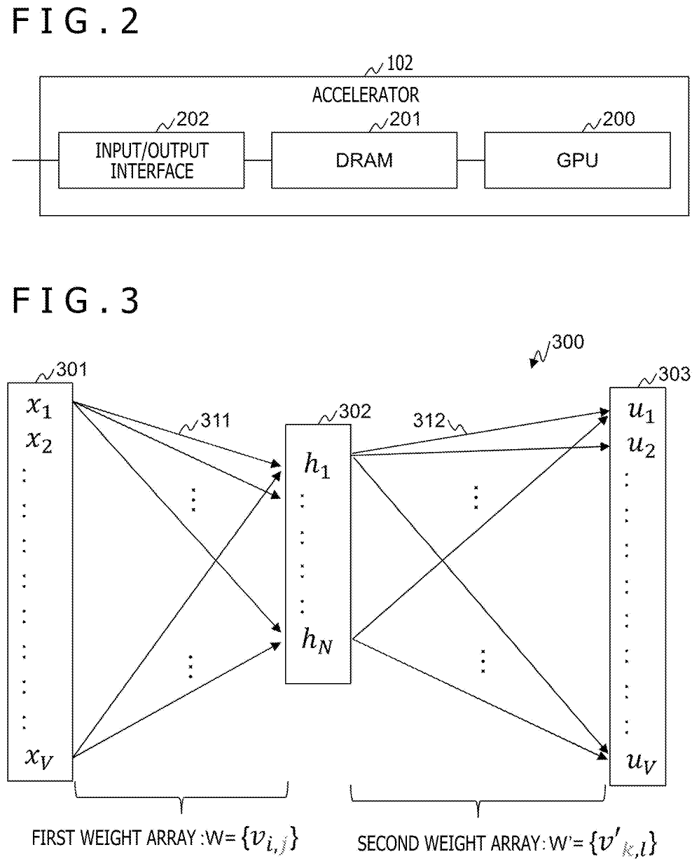

FIG. 2 is a figure illustrating one example of a hardware configuration of the accelerator 102 in the first embodiment.

The accelerator 102 in the first embodiment is a board having a GPU 200 mounted thereon (e.g. a graphics board).

The accelerator 102 includes the GPU 200, a DRAM 201 and an input/output interface 202. The GPU 200 is connected with the DRAM 201, and the DRAM 201 is connected with the input/output interface 202.

The accelerator 102 communicates with an external apparatus such as the CPU 101 via a communication path connected to the input/output interface 202. The communication path is Peripheral Component InterConnect Express (PCI Express; PCI Express is a registered trademark; the same applies hereinafter), for example.

FIG. 2 has been explained thus far.

FIG. 3 is a figure illustrating one example of a structure of a neural network generated by the computer system 10 in the first embodiment.

The neural network 300 illustrated in FIG. 3 includes three layers, which are an input layer 301, a hidden layer 302 and an output layer 303. The input layer 301 includes V elements xᵢ (i is an integer in the range of 1 to V), the hidden layer 302 includes N elements hⱼ (j is an integer in the range of 1 to N), and the output layer 303 includes V elements uₖ (k is an integer in the range of 1 to V). Note that elements in each layer may also be referred to as nodes.

In FIG. 3, the elements in the input layer 301 and the elements in the hidden layer 302 are all connected with each other by edges 311. At this time, there is a relationship like the one indicated by Formula (3) between each element xᵢ in the input layer 301 and each element hᵢ in the hidden layer 302.

$$\begin{matrix}[ Formula 3 ] & \\ {h}_{i} = {\sum }_{j = 1}^{V} {v}_{i , j} {x}_{j} ( i = 1 ∼ N ) & ( 3 )\end{matrix}$$

Here, v_{i,j} represents an element in the first weight array 120 of weights to be applied to connections between the input layer 301 and the hidden layer 302.

Similarly, the elements in the hidden layer 302 and the elements in the output layer 303 are all connected with each other by edges 312. At this time, there is a relationship like the one indicated by Formula (4) between each element h in the hidden layer 302 and each element uₖ in the output layer 303.

$$\begin{matrix}[ Formula 4 ] & \\ {u}_{k} = {\sum }_{l = 1}^{N} {{v}^{′}}_{k , l} {h}_{l} ( k = 1 ∼ V ) & ( 4 )\end{matrix}$$

v′_{k,1} represents an element in the second weight array 121 of weights to be applied to connections between the hidden layer 302 and the output layer 303.

Here, the neural network 300 of word2vec, which is an algorithm for learning vector representations of words by using co-occurrence of words included in sentences, is mentioned as a specific example. A negative sampling method is used in word2vec in a case where word appearance probabilities are computed from the output layer 303 of the neural network 300.

Note that, in the case of word2vec, the training data 140 is data indicating sentences, and the training data array 132 is an array of words appearing in the training data 140 that are stored as array elements in the order of appearance. In addition, each element xᵢ in the input layer 301 is defined such that the element xᵢ becomes a unique vector for a word. Specifically, each word is defined by using a vector whose one component becomes 1, and other components become 0. Vector like the one mentioned before are referred to as one hot vectors. For example, in a case where the training data array 132 includes three elements (The, cats, walk), the one hot vector of “The” is defined as (1, 0, 0), the one hot vector of “cats” is defined as (0, 1, 0), and the one hot vector of “walk” is defined as (0, 0, 1). In this manner, one hot vectors are vectors that represent words uniquely by using 0 and 1 as their elements.

Note that the present invention may be applied to neural networks other than a structure like the one illustrated in FIG. 3.

FIG. 3 has been explained thus far.

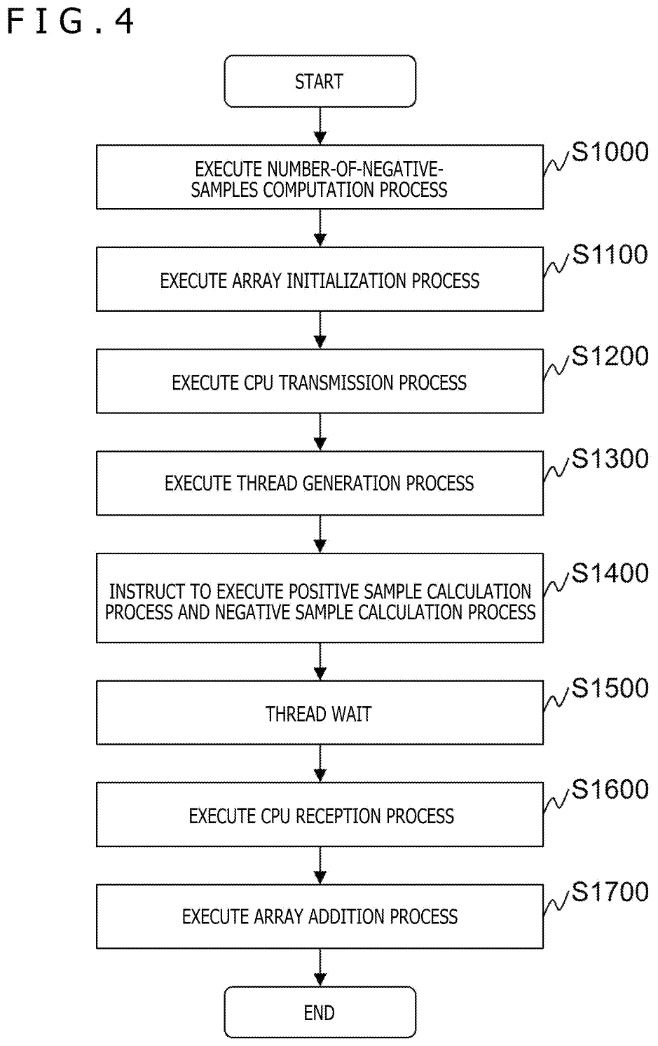

FIG. 4 is a flowchart for explaining one example of a learning process executed by the computer 100 in the first embodiment.

In a case where the computer 100 has received an execution instruction, the computer 100 executes the process explained below. Note that this is one example of the trigger for the process, but is not the sole example.

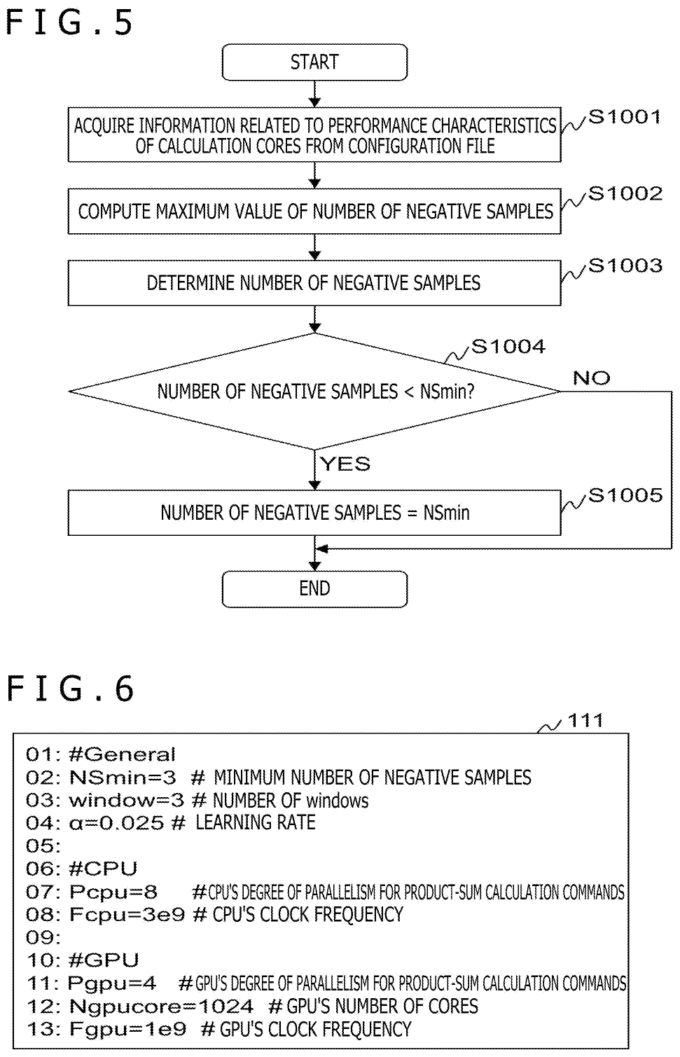

First, the neural network learning section 110 executes a number-of-negative-samples computation process for determining the number of negative samples in a negative sampling method (Step S1000). Details of the number-of-negative-samples computation process are explained by using FIG. 5 and FIG. 6.

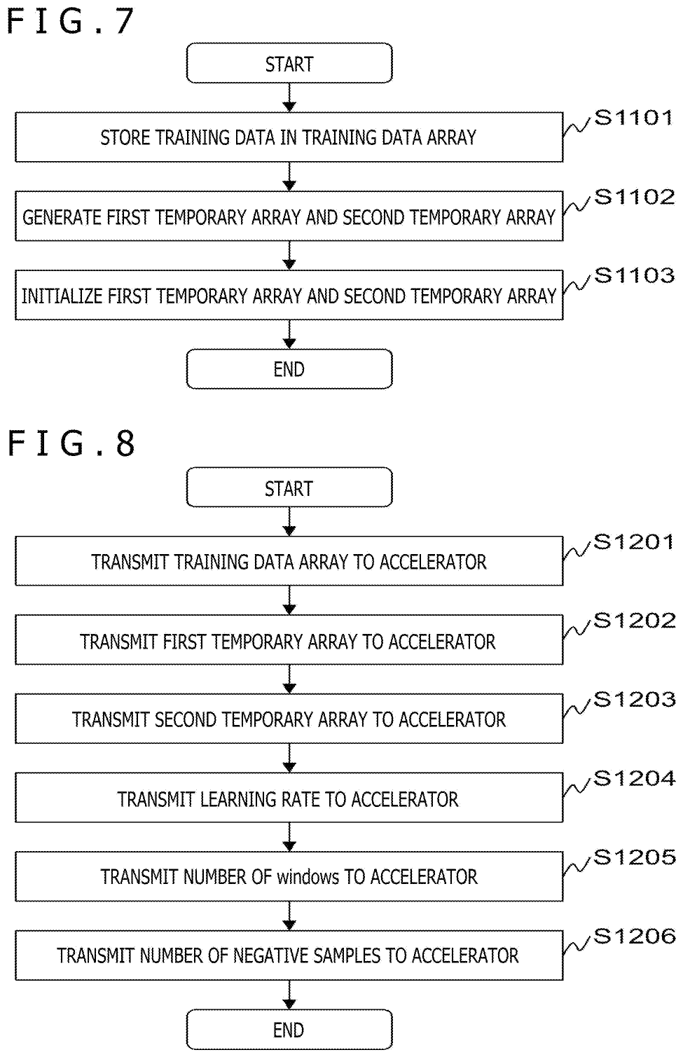

Next, the neural network learning section 110 executes an array initialization process for initializing arrays to be used in the process (Step S1100). Details of the array initialization process are explained by using FIG. 7.

Next, the neural network learning section 110 executes a CPU transmission process for performing setting necessary for execution of the negative sample calculation process (negative sample parallel processing) to be executed by the accelerator 102 (Step S1200). Details of the CPU transmission process are explained by using FIG. 8.

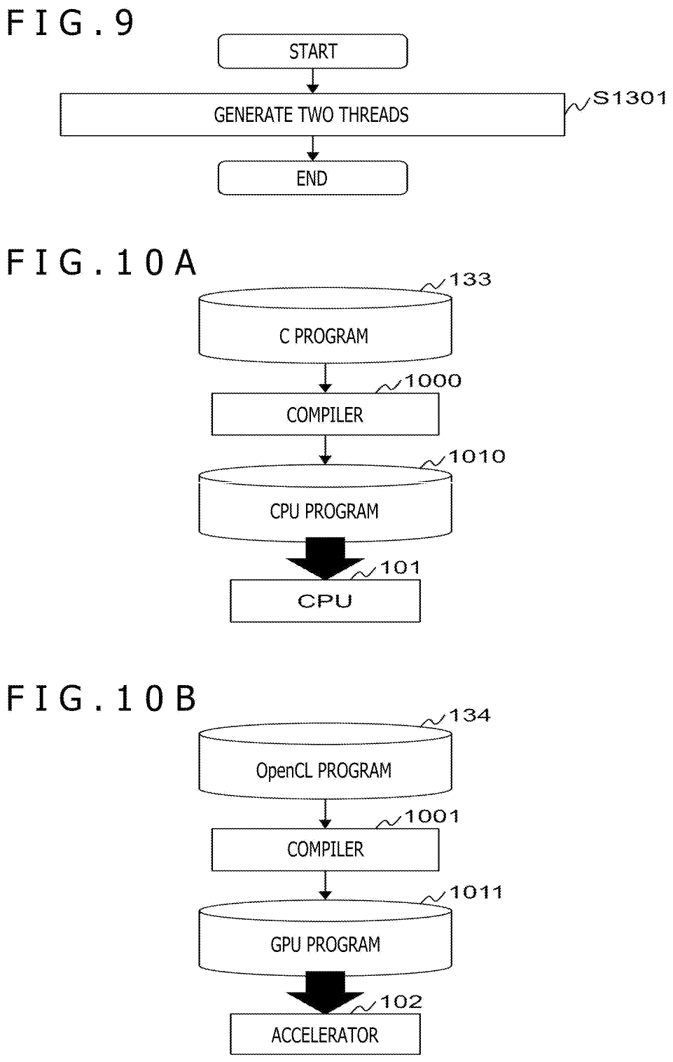

Next, the neural network learning section 110 executes a thread generation process for generating each thread of the positive sample calculation process (positive sample sequential process) and the negative sample calculation process (Step S1300). Details of the thread generation process are explained by using FIG. 9. Note that, in the thread generation process, an identification number of a thread corresponding to the positive sample calculation process is set to “0,” and an identification number of a thread corresponding to the negative sample calculation process is set to “1.”

Next, the neural network learning section 110 instructs the CPU 101 and the accelerator 102 to execute a calculation process corresponding to a thread in accordance with the identification number of the thread (Step S1400), and then proceeds to Step S1500.

Specifically, the neural network learning section 110 instructs the CPU 101 to execute the positive sample calculation process in a case where the identification number of the thread is “0,” and instructs the accelerator 102 to execute the negative sample calculation process in a case where the identification number of the thread is “1.” The instruction to the accelerator 102 for execution of the negative sample calculation process can be realized by using the clEnqueueTask function, which is an accelerator activation function implemented in the OpenCL language.

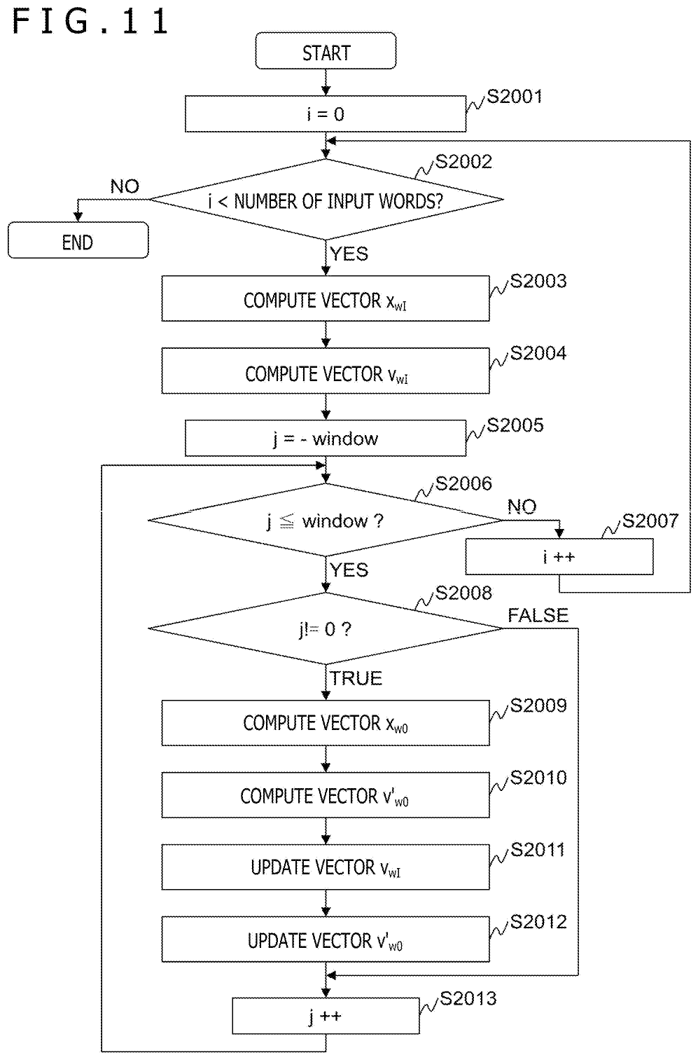

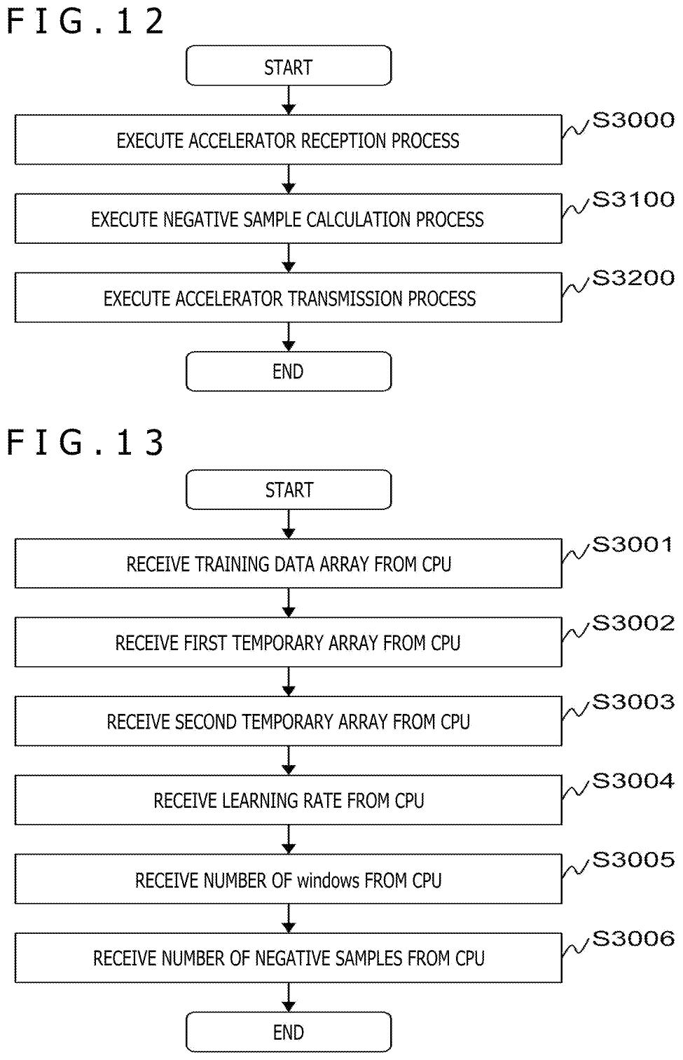

Note that the process executed by the CPU 101 having received the execution instruction is explained by using FIG. 11. The process executed by the accelerator 102 having received the execution instruction is explained by using FIG. 12 to FIG. 16.

At Step S1500, the neural network learning section 110 performs thread wait (Step S1500). After sensing the end of the two threads, the neural network learning section 110 proceeds to Step S1600. Note that the thread wait can be realized by using the thread generation function pthread_join, for example.

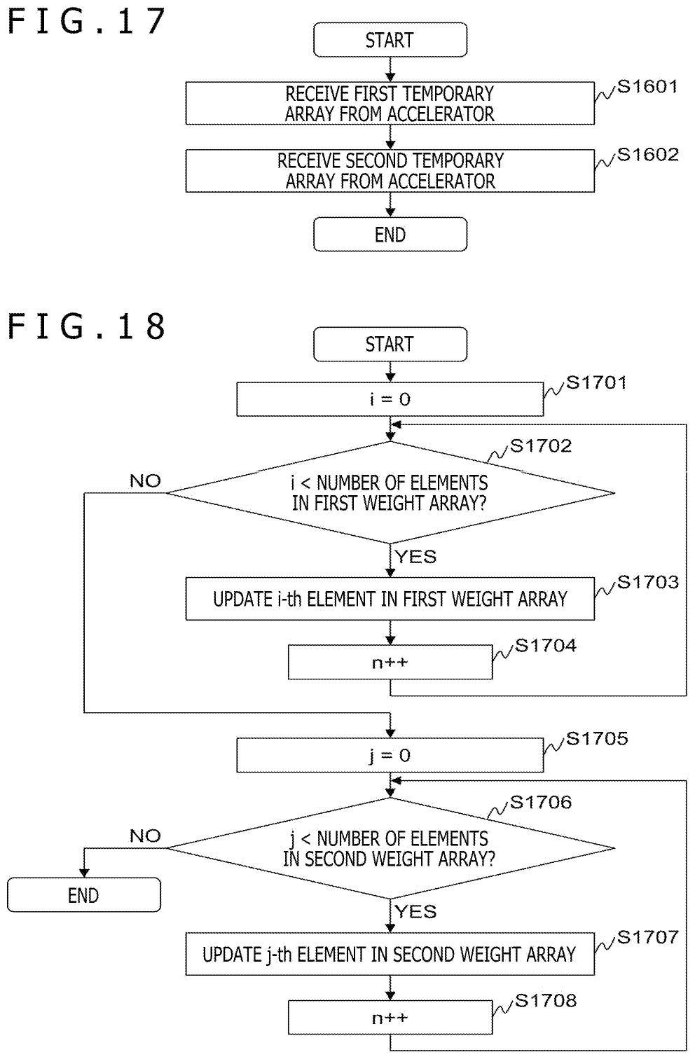

At Step S1600, the neural network learning section 110 executes a CPU reception process for acquiring a result of the negative sample calculation process from the accelerator 102 (Step S1600). Detail of the CPU reception process are explained by using FIG. 17.

Next, on the basis of results of the positive sample calculation process and the negative sample calculation process, the neural network learning section 110 executes an array addition process for updating weight arrays (Step S1700). Thereafter, the neural network learning section 110 ends the process. Details of the array addition process are explained by using FIG. 18.

FIG. 4 has been explained thus far.

FIG. 5 is a flowchart for explaining one example of the number-of-negative-samples computation process executed by the neural network learning section 110 in the first embodiment. FIG. 6 is a figure illustrating one example of the configuration file 111 in the first embodiment.

First, the configuration file 111 is explained. In FIG. 6, leftmost numbers indicate line numbers, and character strings that follow the symbol “#” indicate comments.

The configuration file 111 includes values of parameters necessary for a learning process.

The second line to the fourth line define the values of parameters that do not depend on hardware. Specifically, NSmin in the second line is a parameter indicating the minimum value of the number of negative samples, window in the third line is a parameter indicating the number of windows, and α in the fourth line is a parameter indicating a learning rate. In FIG. 6, NSmin is set to 3, window is set to 3, and α is set to 0.025.

Here, the number of windows is a number that defines how many words, on both sides, from a word of interest are handled as co-occurrence words in a sentence in a case where the neural network 300 in FIG. 3 learns vector representations of words by using co-occurrence of words. For example, in a case where a word of interest in a sentence “Two cats sat on the floor” is “sat,” and window is 1, words to be regarded as co-occurrence words of “sat” are “cats” and “on.” On the other hand, in a case where a word of interest is “sat,” and window is 2, words to be regarded as co-occurrence words of “sat” are “Two,” “cats,” “on” and “the.”

The seventh line and the eighth line define values of parameters related to the CPU 101. Pcpu in the seventh line is a parameter indicating the degree of parallelism for product-sum calculation commands of the CPU 101, and Fcpu in the eighth line is a parameter indicating the clock frequency of the CPU 101. In FIG. 6, Pcpu is set to 8, and Fcpu is set to 3e9. Note that Fcpu is expressed in Hz. In addition, 3e9 is an abbreviation of 3×10⁹.

The eleventh line to the thirteenth line define values of parameters related to the GPU 200. Pgpu in the eleventh line is a parameter indicating the degree of parallelism for product-sum calculation commands of the GPU 200, Ngpucore in the twelfth line is a parameter indicating the number of calculation cores of the GPU 200, and Fgpu in the thirteenth line is a parameter indicating the clock frequency of the GPU 200. In FIG. 6, Pgpu is set to 4, Ngpucore is set to 1024, and Fgpu is set to 1e9. Note that Fgpu is expressed in Hz.

FIG. 6 has been explained thus far.

The neural network learning section 110 acquires information about performance characteristics of calculation cores from the configuration file 111 (Step S1001).

Here, as information about performance characteristics of calculation cores of the CPU 101, the degree of parallelism for product-sum calculation commands and the clock frequency of the CPU 101 are acquired, and as information about performance characteristics of calculation cores of the GPU 200, the degree of parallelism for product-sum calculation commands, the number of calculation cores and the clock frequency of the GPU 200 are acquired.

Note that the information about the performance characteristics of the calculation cores may be acquired from other than the configuration file 111. For example, the information may be acquired from the OS, or may be acquired directly from the CPU 101 and the GPU 200.

Next, on the basis of execution time of the positive sample calculation process (positive sample sequential process) and the negative sample calculation process (negative sample parallel processing), the neural network learning section 110 computes the maximum value of the number of negative samples (Step S1002). In the present embodiment, the maximum value of the number of negative samples is computed on the basis of Formula (5).

$$\begin{matrix}[ Formula 5 ] & \\ \begin{matrix}Number of \\ negative samples\end{matrix} = \frac{( Pgpu \times Ngpucore \times Fgpu )}{( Pcpu \times Fcpu )} & ( 5 )\end{matrix}$$

Formula (5) is a formula that is derived in a case where it is hypothesized that the execution time of the positive sample calculation process performed by the CPU 101 indicated by Formula (6) and the execution time of the negative sample calculation process performed by the GPU 200 indicated by Formula (7) are equal to each other. Here, Nma represents the number of all the product-sum calculations in the positive sample calculation process.

$$\begin{matrix}[ Formula 6 ] & \\ \frac{Nma}{( Pcpu \times Fcpu )} & ( 6 ) \\ [ Formula 7 ] & \\ Nma \times \frac{Number of negative samples}{( Pgpu \times Fgpu \times Ngpucore )} & ( 7 )\end{matrix}$$

Note that in a case where the value computed on the basis of Formula (5) is not an integer, the neural network learning section 110 converts the value to an integer by performing a process such as rounding off, rounding up or rounding down.

Next, on the basis of the maximum value of the number of negative samples, the neural network learning section 110 determines the number of negative samples to be set (Step S1003).

For example, the neural network learning section 110 may set the number of negative samples to the maximum value of the number of negative samples. In addition, the neural network learning section 110 may present the maximum value of the number of negative samples to a user, and receive an input from the user.

Next, the neural network learning section 110 decides whether or not the determined number of negative samples is smaller than the minimum number of negative samples NSmin (Step S1004).

In a case where the determined number of negative samples is equal to or larger than the minimum number of negative samples NSmin, the neural network learning section 110 ends the number-of-negative-samples computation process.

In a case where the determined number of negative samples is smaller than the minimum number of negative samples NSmin, the neural network learning section 110 sets the number of negative samples to the minimum number of negative samples NSmin (Step S1005), and then ends the number-of-negative-samples computation process. By performing control such that the number of negative samples does not become smaller than the minimum number of negative samples, the inference accuracy of the neural network 300 can be kept at or above a certain level.

As explained above, the maximum value of the number of negative samples is determined such that the difference between the execution time of the positive sample calculation process and the execution time of the negative sample calculation process is made small in the present embodiment. Since the number of negative samples is determined within a range between the maximum value and the minimum value, a length of time required for learning processes can be reduced to be in a practical range, and a model with high inference accuracy can be generated.

FIG. 5 has been explained thus far.

FIG. 7 is a flowchart for explaining one example of the array initialization process executed by the neural network learning section 110 in the first embodiment.

The neural network learning section 110 reads out the training data 140 from the secondary storage apparatus 104, and stores the training data 140 in the training data array 132 (Step S1101).

Next, the neural network learning section 110 generates the first temporary array 130 having the same type and same number of elements as the first weight array 120, and the second temporary array 131 having the same type and same number of elements as the second weight array 121 (Step S1102).

Next, the neural network learning section 110 initializes the first temporary array 130 and the second temporary array 131 (Step S1103). Thereafter, the neural network learning section 110 ends the array initialization process.

Specifically, all the elements in each of the first temporary array 130 and the second temporary array 131 are set to 0.

The array initialization process is executed for preparing the first temporary array 130 and the second temporary array 131 used in the negative sample calculation process instead of the first weight array 120 and the second weight array 121 used in the positive sample calculation process.

FIG. 7 has been explained thus far.

FIG. 8 is a flowchart for explaining one example of the CPU transmission process executed by the neural network learning section 110 in the first embodiment.

The neural network learning section 110 transmits the training data array 132 to the accelerator 102 (Step S1201).

Next, the neural network learning section 110 transmits the first temporary array 130 to the accelerator 102 (Step S1202).

Next, the neural network learning section 110 transmits the second temporary array 131 to the accelerator 102 (Step S1203).

Next, the neural network learning section 110 transmits the learning rate read out from the configuration file 111 to the accelerator 102 (Step S1204).

Next, the neural network learning section 110 transmits the number of windows read out from the configuration file 111 to the accelerator 102 (Step S1205).

Next, the neural network learning section 110 transmits the number of negative samples computed in the number-of-negative-samples computation process to the accelerator 102 (Step S1206). Thereafter, the neural network learning section 110 ends the CPU transmission process.

Note that the data transmission to the accelerator 102 can be realized, for example, by using the clEnqueueWriteBuffer function, which is a function for data transfer from a CPU to an accelerator in the OpenCL language, for example.

FIG. 8 has been explained thus far.

FIG. 9 is a flowchart for explaining one example of the thread generation process executed by the neural network learning section 110 in the first embodiment.

The neural network learning section 110 generates a thread of each of the positive sample calculation process (positive sample sequential process) and the negative sample calculation process (negative sample parallel processing) (Step S1301), and ends the thread generation process.

At this time, the neural network learning section 110 sets the thread number of the thread of the positive sample calculation process to “0,” and sets the thread number of the thread of the negative sample calculation process (negative sample parallel processing) to “1.”

Note that the thread generation can be realized by using the thread generation function pthread_create, for example.

FIG. 9 has been explained thus far.

FIG. 10A and FIG. 10B are figures for explaining the compilation process executed by the neural network learning section 110 in the first embodiment.

A compiler 1000 included in the program that realizes the neural network learning section 110 compiles the C program 133 to thereby convert the C program 133 into a CPU program 1010 that the CPU 101 can execute. The compiler 1000 is a GNU compiler collection (GCC), for example. The CPU program 1010 is loaded onto the CPU 101, and is executed in cooperation with the accelerator 102.

A compiler 1001 included in the program that realizes the neural network learning section 110 compiles the OpenCL program 134 to thereby convert the OpenCL program 134 into an accelerator program 1011 that the accelerator 102 can execute. The compiler 1001 in the first embodiment is a compiler for GPU, and, for example, is a compiler described in “Kikuzato Chigusa, Making Full Use of GPU: “OpenCL” of Snow Leopard, https://ascii.jp/elem/000/000/456/456973/index-2.html, 2009, [Date of Retrieval: Jun. 7, 2019].” The accelerator program 1011 is loaded onto the accelerator 102, and executed in cooperation with the CPU 101.

Next, a process executed by the CPU 101 having received an instruction from the neural network learning section 110 is explained. In a case where the CPU 101 has received an execution instruction, the CPU 101 starts the positive sample calculation process.

FIG. 11 is a flowchart for explaining one example of the positive sample calculation process executed by the CPU 101 in the first embodiment.

The CPU 101 initializes a variable i (Step S2001). Specifically, the variable i is set to 0.

The CPU 101 decides whether or not the variable i is smaller than the number of input words (Step S2002). Note that the number of input words is equal to the number of elements in the training data array 132.

In a case where the variable i is equal to or larger than the number of input words, the CPU 101 ends the positive sample calculation process.

In a case where the variable i is smaller than the number of input words, the CPU 101 executes a calculation of the function func that outputs a one hot vector corresponding to an i-th word in the training data array 132, and computes a vector x_{W_I} as indicated by Formula (8) (Step S2003). Note that w_{I} is expressed as w_I for a notation-related reason.

[Formula 8]

x_{w}_{_{I}}=func(i-th word) (8)

Next, the CPU 101 computes a vector v_{w_I} by multiplying the vector x_{W_I} by the first weight array 120 as indicated by Formula (9) (Step S2004). Note that w_{I} is expressed as w_I for a notation-related reason.

[Formula 9]

v_{w}_{_{I}}=(First weight array)×x_{w}_{_{I}} (9)

Since the vector x_{W_I} is a vector in a format like (0, 1, 0), the computation of the vector v_{W_I} corresponds to an extraction of a line in the first weight array 120 corresponding to the i-th word.

Next, the CPU 101 initializes a variable j (Step S2005). Specifically, the variable j is set to -window.

Next, the CPU 101 decides whether or not the variable j is equal to or smaller than window (Step S2006). Processes at and after Step S2008 are a loop process of learning co-occurrence with window words before and after a word of interest (in the case of j=0).

In a case where the variable j is larger than window, the CPU 101 sets the variable i to a value obtained by adding 1 to the variable i (Step S2007), and then returns to Step S2002.

In a case where the variable j is equal to or smaller than window, the CPU 101 decides whether or not the variable j is equal to 0 (Step S2008). Here, in a case where the variable j is not equal to 0, the decision result is TRUE, and in a case where the variable j is equal to 0, the decision result is FALSE. Note that processes at and after Step S2009 are performed only in a case where the variable j is not equal to 0 so as to avoid a computation of co-occurrence with the word of interest (in the case of j=0) itself.

In a case where the variable j is equal to 0 (in a case where the result of Step S2008 is FALSE), the CPU 101 proceeds to Step S2013.

In a case where the variable j is not equal to 0 (in a case where the result of Step S2008 is TRUE), the CPU 101 executes a calculation of the function func that outputs a one hot vector corresponding to an (i+j)-th word in the training data array 132, and computes a vector x_{W_0} as indicated by Formula (10) (Step S2009). Note that w₀ is expressed as w_0 for a notation-related reason.

[Formula 10]

x_{w}_{₀}=func((i+j)-th word) (10)

Next, the CPU 101 computes a vector v′_{w_0} by multiplying the vector x_{w_0} by the first weight array 120 and the second weight array 121 as indicated by Formula (11) (Step S2010). Note that w₀ is expressed as w_0 for a notation-related reason.

[Formula 11]

v′_{w}_{₀}=(Second weight array)×(First weight array)×x_{w}_{₀} (11)

Next, the CPU 101 updates the vector v_{w_I} by executing a calculation indicated by Formula (12) (Step S2011). Note that the argument of the sigmoid function a is the inner product of the vector v′_{w_0} and the vector v_{w_I}.

[Formula 12]

v_{w}_{_{I}}=v_{w}_{_{I}}−α(σ(v′_{w}_{₀}·v_{w}_{_{I}})−1)v′_{w}_{₀} (12)

The update of the vector v_{w_I} corresponds to an update of elements in the first weight array 120 corresponding to the i-th word.

Next, the CPU 101 updates the vector v′_{w_0} by executing a calculation indicated by Formula (13) (Step S2012), and proceeds to Step S2013. Note that the argument of the sigmoid function σ is the inner product of the vector v′_{w_0} and the vector v_{w_I}.

[Formula 13]

v_{w}_{₀}^{′}=v_{w}_{₀}^{′}−α(σ(v′_{w}_{₀}·v_{w}_{_{I}})−1)v_{w}_{_{I}} (13)

The update of the vector v′_{w_0} corresponds to an update of elements in the second weight array 121 corresponding to the (i+j)-th word.

At Step S2013, the CPU 101 sets the variable j to a value obtained by adding 1 to the variable j (Step S2013), and then returns to Step S2006.

FIG. 11 has been explained thus far.

Next, a process executed by the accelerator 102 having received an instruction from the neural network learning section 110 is explained. In a case where the accelerator 102 has received an execution instruction, the accelerator 102 starts the accelerator process.

FIG. 12 is a flowchart for explaining one example of the accelerator process executed by the accelerator 102 in the first embodiment.

The accelerator 102 executes an accelerator reception process in order to receive data transmitted in the CPU transmission process (Step S3000). Details of the accelerator reception process are explained by using FIG. 13.

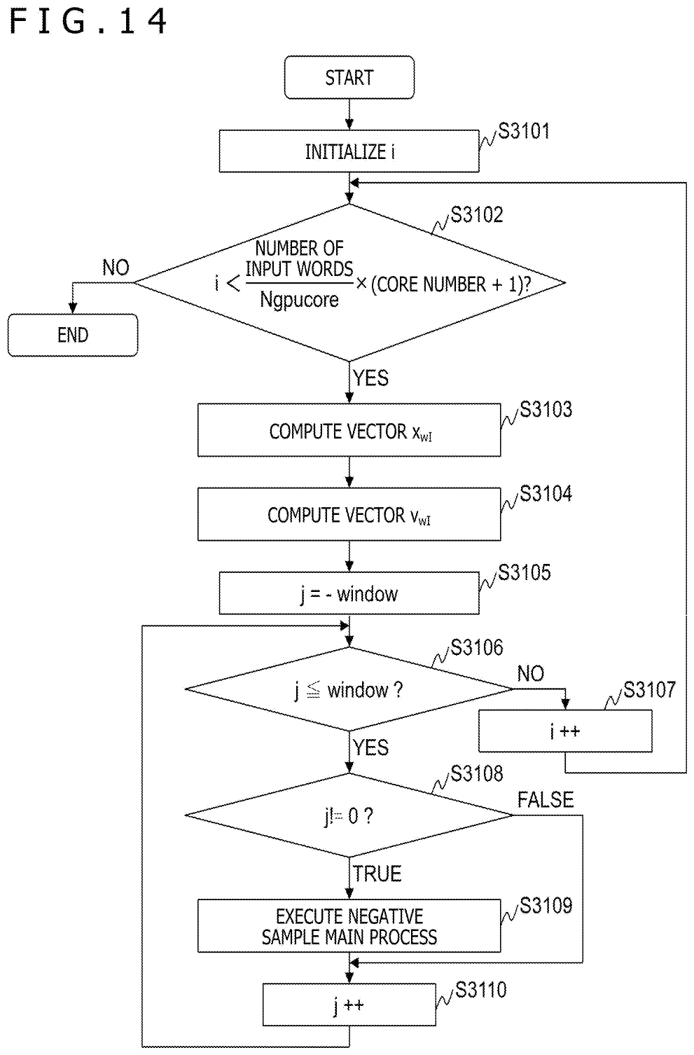

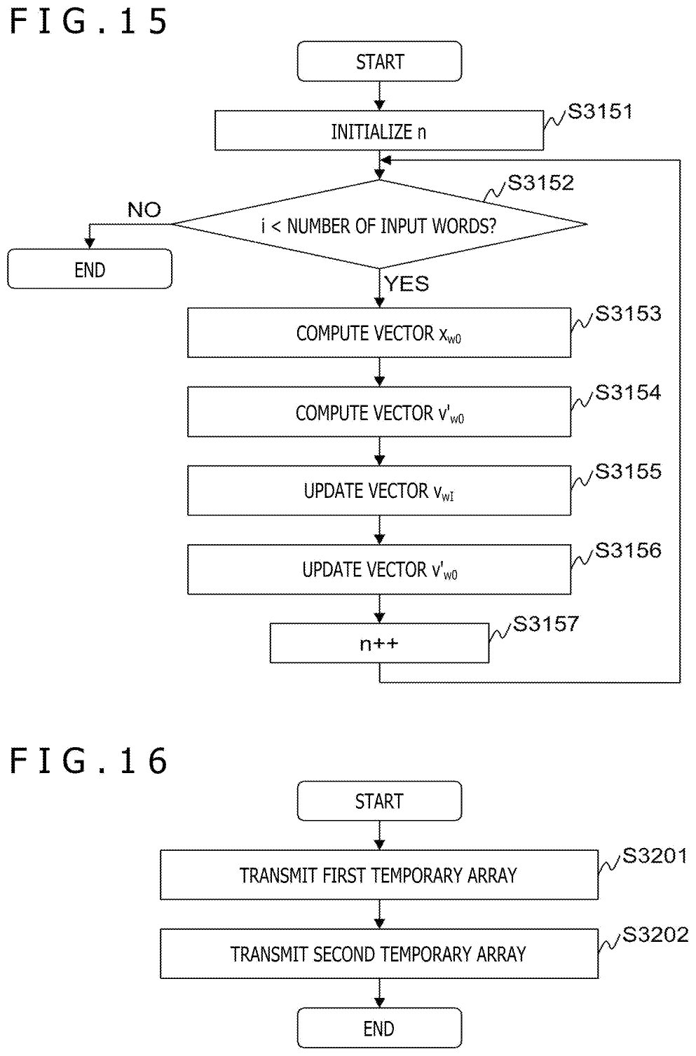

Next, the accelerator 102 executes the negative sample calculation process (negative sample parallel processing) (Step S3100). Details of the negative sample calculation process are explained by using FIG. 14 and FIG. 15.

Next, the accelerator 102 executes an accelerator transmission process in order to transmit a result of the negative sample calculation process to the CPU 101 (Step S3200). Thereafter, the accelerator 102 ends the accelerator process. Details of the accelerator transmission process are explained by using FIG. 16.

FIG. 12 has been explained thus far.

FIG. 13 is a flowchart for explaining one example of the accelerator reception process executed by the accelerator 102 in the first embodiment.

The accelerator 102 receives the training data array 132 (Step S3001), and stores the training data array 132 on the DRAM 201.

Next, the accelerator 102 receives the first temporary array 130 (Step S3002), and stores the first temporary array 130 on the DRAM 201.

Next, the accelerator 102 receives the second temporary array 131 (Step S3003), and stores the second temporary array 131 on the DRAM 201.

Next, the accelerator 102 receives the learning rate (Step S3004), and stores the learning rate on the DRAM 201.

Next, the accelerator 102 receives the number of windows (Step S3005), and stores the number of windows on the DRAM 201.

Next, the accelerator 102 receives the number of negative samples (Step S3006), and stores the number of negative samples on the DRAM 201. Thereafter, the accelerator 102 ends the accelerator reception process.

FIG. 13 has been explained thus far.

FIG. 14 is a flowchart for explaining one example of the negative sample calculation process executed by the accelerator 102 in the first embodiment.

Although variables i and j illustrated below are represented by the same characters as the variables i and j illustrated in the positive sample calculation process, they are separate entities. That is, the variables i and j in FIG. 11, and the variables i and j in FIG. 14 are independent variables.

The accelerator 102 initializes the variable i (Step S3101). Specifically, the accelerator 102 sets the initial value of the variable i to a value computed by using Formula (14). The number of input words is equal to the number of elements in the training data array 132.

$$\begin{matrix}[ Formula 14 ] & \\ \frac{Number of input words}{Ngpucore} \times Core number & ( 14 )\end{matrix}$$

This is a process for assigning a process to each calculation core of the GPU 200 such that there is no overlap within the training data array 132. Note that identification numbers which are integers in the range of 0 to (Ngpucore-1) are allocated to calculation cores of the GPU 200.

Next, the accelerator 102 decides whether or not the variable i is smaller than the value of Formula (15) (Step S3102).

$$\begin{matrix}[ Formula 15 ] & \\ \frac{Number of input words}{Ngpucore} \times ( Core number + 1 ) & ( 15 )\end{matrix}$$

In a case where the variable i is equal to or larger than the value of Formula (15), the accelerator 102 ends the negative sample calculation process.

In a case where the variable i is smaller than the value of Formula (15), the accelerator 102 executes a calculation of the function func that outputs a one hot vector corresponding to an i-th word in the training data array 132, and computes a vector x_{w_I} as indicated by Formula (16) (Step S3103). Note that w_{I} is expressed as w_I for a notation-related reason.

[Formula 16]

x_{w}_{_{I}}=func(i-th word) (16)

Next, the accelerator 102 computes a vector v_{w_I} by multiplying the vector x_{w_I} by the first temporary array 130 as indicated by Formula (17) (Step S3104). Note that w_{I} is expressed as w_I for a notation-related reason.

[Formula 17]

v_{w}_{_{I}}=(First temporary array)×x_{w}_{_{I}} (17)

Since the vector x_{w_I} is a vector in a format like (0, 1, 0), the computation of the vector v_{w_I} corresponds to an extraction of a line in the first temporary array 130 corresponding to the i-th word.

Next, the accelerator 102 initializes the variable j (Step S3105). Specifically, the variable j is set to -window.

Next, the accelerator 102 decides whether or not the variable j is equal to or smaller than window (Step S3106).

In a case where the variable j is larger than window, the accelerator 102 sets the variable i to a value obtained by adding 1 to the variable i (Step S3107), and then returns to Step S3102.

In a case where the variable j is equal to or smaller than window, the accelerator 102 decides whether or not the variable j is equal to 0 (Step S3108). Here, in a case where the variable j is not equal to 0, the decision result is TRUE, and in a case where the variable j is equal to 0, the decision result is FALSE.

In a case where the variable j is equal to 0 (in a case where the result of Step S3108 is FALSE), the accelerator 102 proceeds to Step S3110.

In a case where the variable j is not equal to 0 (in a case where the result of Step S3108 is TRUE), the accelerator 102 executes a negative sample main process (Step S3109), and then proceeds to Step S3110. Details of the negative sample main process are explained by using FIG. 15.

At Step S3110, the accelerator 102 sets the variable j to a value obtained by adding 1 to the variable j (Step S3110), and then returns to Step S3106.

FIG. 14 has been explained thus far.

FIG. 15 is a flowchart for explaining one example of the negative sample main process executed by the accelerator 102 in the first embodiment.

The accelerator 102 initializes a variable n (Step S3151). Specifically, the variable n is set to 0.

Next, the accelerator 102 decides whether or not the variable n is smaller than the number of negative samples (Step S3152).

In a case where the variable n is equal to or larger than the number of negative samples, the accelerator 102 ends the negative sample main process.

In a case where the variable n is smaller than the number of negative samples, the accelerator 102 randomly selects an element (word) in the training data array 132 as a negative sample, and, as indicated by Formula (18), executes a calculation of the function func that outputs a one hot vector corresponding to the word, and computes the vector x_{w_0} (Step S3153). Note that w₀ is expressed as w_0 for a notation-related reason.

[Formula 18]

x_{w}_{₀}=func(Randomly selected word) (18)

Next, the accelerator 102 computes the vector v′_{w_0} by multiplying the vector x_{w_0} by the first temporary array 130 and the second temporary array 131 as indicated by Formula (19) (Step S3154). Note that w₀ is expressed as w_0 for a notation-related reason.

[Formula 19]

v′_{w}_{₀}=(Second temporary array)×(First temporary array)×x_{w}_{₀} (19)

The computation of the vector v′_{w_0} corresponds to an extraction of a line in the second temporary array 131 corresponding to the randomly selected word.

Next, the accelerator 102 updates the vector v_{w_I} by executing a calculation indicated by Formula (20) (Step S3155). Note that the argument of the sigmoid function σ is the inner product of the vector v′_{w_0} and the vector v_{w_I}.

[Formula 20]

v_{w}_{_{I}}=v_{w}_{_{I}}−α(σ(v′_{w}_{₀}·v_{w}_{_{I}})−1)v′_{w}_{₀} (20)

The update of the vector v_{w_I} corresponds to an update of elements in the first temporary array 130 corresponding to the i-th word.

Next, the accelerator 102 updates the vector v′_{w_0} by executing a calculation indicated by Formula (21) (Step S3156). Note that the argument of the sigmoid function σ is the inner product of the vector v′_{w_0} and the vector v_{w_I}.

[Formula 21]

v_{w}_{₀}^{′}=v_{w}_{₀}^{′}−α(σ(v_{w}_{₀}^{′}·v_{w}_{_{I}})−1)v_{w}_{_{I}} (21)

The update of the vector v′_{w_0} corresponds to an update of elements in the second temporary array 131 corresponding to the randomly selected word (negative sample).

Next, the accelerator 102 sets the variable n to a value obtained by adding 1 to the variable n (Step S3157), and then returns to Step S3152.

FIG. 15 has been explained thus far.

FIG. 16 is a flowchart for explaining one example of the accelerator transmission process executed by the accelerator 102 in the first embodiment.

The accelerator 102 transmits the first temporary array 130 (Step S3201), and transmits the second temporary array 131 (Step S3202) to the CPU 101. Thereafter, the accelerator 102 ends the accelerator transmission process.

FIG. 16 has been explained thus far.

Next, a process executed after the thread wait is explained.

FIG. 17 is a flowchart for explaining one example of the CPU reception process executed by the neural network learning section 110 in the first embodiment.

The neural network learning section 110 receives the first temporary array 130 from the accelerator 102 (Step S1601). At this time, by using the received first temporary array 130, the neural network learning section 110 updates the first temporary array 130 stored on the main storage apparatus 103.

Next, the neural network learning section 110 receives the second temporary array 131 from the accelerator 102 (Step S1602). Thereafter, the neural network learning section 110 ends the CPU reception process. At this time, by using the received second temporary array 131, the neural network learning section 110 updates the second temporary array 131 stored on the main storage apparatus 103.

Note that the data reception from the accelerator 102 can be realized, for example, by using the clEnqueueReadBuffer function, which is a function for data transfer from an accelerator to a CPU in the OpenCL language.

FIG. 17 has been explained thus far.

FIG. 18 is a flowchart for explaining one example of the array addition process executed by the neural network learning section 110 in the first embodiment.

The neural network learning section 110 initializes the variable i (Step S1701). Specifically, the variable i is set to 0.

Next, the neural network learning section 110 decides whether or not the variable i is smaller than the number of elements in the first weight array 120 (Step S1702).

In a case where the variable i is smaller than the number of elements in the first weight array 120, the neural network learning section 110 updates an i-th element in the first weight array 120 (Step S1703).

Specifically, the neural network learning section 110 adds the i-th element in the first temporary array 130 to the i-th element in the first weight array 120.

Next, the neural network learning section 110 sets the variable i to a value obtained by adding 1 to the variable i (Step S1704), and then returns to Step S1702.

In a case where, at Step S1702, the variable i is equal to or larger than the number of elements in the first weight array 120, the neural network learning section 110 initializes the variable j (Step S1705). Specifically, the variable j is set to 0.

The neural network learning section 110 decides whether or not the variable j is smaller than the number of elements in the second weight array 121 (Step S1706).

In a case where the variable j is smaller than the number of elements in the second weight array 121, the neural network learning section 110 updates a j-th element in the second weight array 121 (Step S1707).

Specifically, the neural network learning section 110 adds the j-th element in the second temporary array 131 to the j-th element in the second weight array 121.

Next, the neural network learning section 110 sets the variable j to a value obtained by adding 1 to the variable j (Step S1708), and then returns to Step S1706.

In a case where, at Step S1706, the variable j is equal to or larger than the number of elements in the second weight array 121, the neural network learning section 110 ends the array addition process.

FIG. 18 has been explained thus far.

According to the first embodiment, the neural network learning section 110 sets the maximum value of the number of negative samples to a number of negative samples that minimizes the difference of execution time between the positive sample calculation process (positive sample sequential process) and the negative sample calculation process (negative sample parallel processing), and determines the actual number of negative samples on the basis of the maximum value. Thereby, a model with high inference accuracy can be generated in a practical length of time required for learning processes.

### Second Embodiment

A second embodiment is different from the first embodiment in that the accelerator 102 having a FPGA mounted thereon is used. In the following, mainly, differences of the second embodiment from the first embodiment are explained.

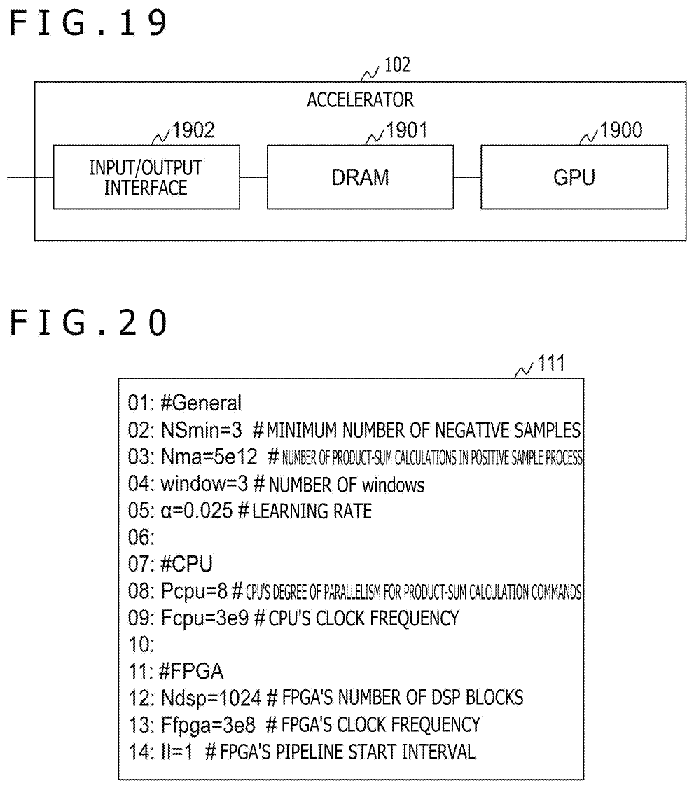

The configuration of the computer system 10 in the second embodiment is identical to that in the first embodiment. The configuration of the accelerator 102 in the second embodiment is different from that in the first embodiment. FIG. 19 is a figure illustrating one example of a hardware configuration of the accelerator 102 in the second embodiment.

The accelerator 102 in the second embodiment is a board having a FPGA 1900 mounted thereon.

The accelerator 102 includes the FPGA 1900, a DRAM 1901 and an input/output interface 1902. The FPGA 1900 is connected with the DRAM 1901, and the DRAM 1901 is connected with the input/output interface 1902.

FIG. 19 has been explained thus far.

The number-of-negative-samples computation process in the second embodiment is performed in the same process flow as in the first embodiment, but is different from its counterpart in terms of the method of computing the maximum value of the number of negative samples. First, after the configuration file 111 in the second embodiment is explained, the method of computing the maximum value of the number of negative samples in the second embodiment is explained.

FIG. 20 is a figure illustrating one example of the configuration file 111 in the second embodiment.

In FIG. 20, leftmost numbers indicate line numbers, and character strings that follow “#” indicate comments.

The second line to the fifth line define the values of parameters that do not depend on hardware. Specifically, NSmin in the second line is a parameter indicating the minimum value of the number of negative samples, Nma in the third line is a parameter indicating the number of product-sum calculations in the positive sample calculation, window in the fourth line is a parameter indicating the number of windows, and α in the fifth line is a parameter indicating a learning rate. In FIG. 20, NSmin is set to 3, Nma is set to 5e12, window is set to 3, and α is set to 0.025.

The eighth line and the ninth line define values of parameters related to the CPU 101. Pcpu in the eighth line is a parameter indicating the degree of parallelism for product-sum calculation commands of the CPU 101, and Fcpu in the ninth line is a parameter indicating the clock frequency of the CPU 101. In FIG. 20, Pcpu is set to 8, and Fcpu is set to 3e9. Note that Fcpu is expressed in Hz.

The twelfth line to the fourteenth line define values of parameters related to the FPGA 1900. Ndsp in the twelfth line is a parameter indicating the number of DSP blocks of the FPGA 1900, Ffgpa in the thirteenth line is a parameter indicating the clock frequency of the FPGA 1900, and II in the fourteenth line is a parameter indicating a pipeline start interval of the FPGA 1900. In FIG. 20, Ndsp is set to 1024, Ffgpa is set to 3e8, and II is set to 1.

Note that the pipeline start interval II can be checked in an output of a compiler for FPGA, or the like.

FIG. 20 has been explained thus far.

Next, the method of computing the maximum value of the number of negative samples in the second embodiment is explained. In the second embodiment, the neural network learning section 110 computes the maximum value of the number of negative samples on the basis of Formula (22) at Step S1002.

$$\begin{matrix}[ Formula 22 ] & \\ \begin{matrix}Number of \\ negative samples\end{matrix} = \frac{\frac{Nma \times Ffpga}{Pcpu \times Fcpu} - \frac{Nma}{Ndsp}}{II} + 1 & ( 22 )\end{matrix}$$

Formula (22) is a formula that is derived in a case where it is hypothesized that the execution time of the positive sample sequential process performed by the CPU 101 indicated by Formula (6), and the execution time of the negative sample parallel processing (pipeline parallel processing) performed by the FPGA 1900 indicated by Formula (23) are equal to each other.

$$\begin{matrix}[ Formula 23 ] & \\ \frac{\frac{Nma}{Ndsp} + ( number of negative samples - 1 ) \times II}{Ffgpa} & ( 23 )\end{matrix}$$

Note that a computation formula for computing the execution time of the pipeline parallel processing is described in “Hironori Kasahara, Parallel Processing Technology, CORONA PUBLISHING CO., LTD., 1991.”

Note that in a case where the value computed on the basis of Formula (22) is not an integer, the neural network learning section 110 converts the value to an integer by performing a process such as rounding off, rounding up or rounding down.

The array initialization process, the CPU transmission process, the thread generation process, the thread wait, the CPU reception process and the array addition process in the second embodiment are identical to those in the first embodiment.

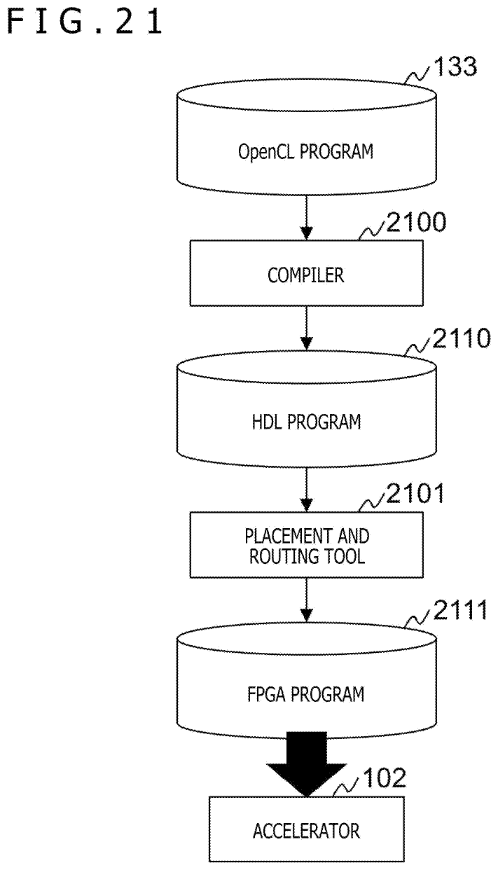

Note that the compilation process for the OpenCL program 134 in the second embodiment is as follows. FIG. 21 is a figure for explaining the compilation process executed by the neural network learning section 110 in the second embodiment.

A compiler 2100 included in the program that realizes the neural network learning section 110 compiles the OpenCL program 134 to thereby convert the OpenCL program 134 into a hardware description language (HDL: Hardware Description Language) program 2110 described in a HDL such as Verilog HDL. The compiler 2100 is an OpenCL compiler for FPGA described in “Tomasz S. Czajkowski, David Neto, Michael Kinsner, Utku Aydonat, Jason Wong, Dmitry Denisenko, Peter Yiannacouras, John Freeman, Deshanand P. Singh and Stephen D. Brown, “OpenCL for FPGAs: Prototyping a Compiler,” Proceedings of the International Conference on Engineering of Reconfigurable Systems and Algorithms, 2012,” for example.

Furthermore, a placement and routing tool 2101 included in the program that realizes the neural network learning section 110 converts the HDL program 2110 into a FPGA program 2111 describing the circuit and placement configuration of the FPGA 1900. The placement and routing tool 2101 is a tool described in “Tomasz S. Czajkowski, David Neto, Michael Kinsner, Utku Aydonat, Jason Wong, Dmitry Denisenko, Peter Yiannacouras, John Freeman, Deshanand P. Singh and Stephen D. Brown, “OpenCL for FPGAs: Prototyping a Compiler,” Proceedings of the International Conference on Engineering of Reconfigurable Systems and Algorithms, 2012” (e.g. Quartus II), for example. The FPGA program is also referred to as bitstream.

In this manner, the compiler 2100 and the placement and routing tool 2101 convert the OpenCL program 134 into the FPGA program 2111 for realizing a pipeline parallel processing performed by the FPGA 1900 including a high-speed, less power-consuming circuit with a small area.

FIG. 21 has been explained thus far.

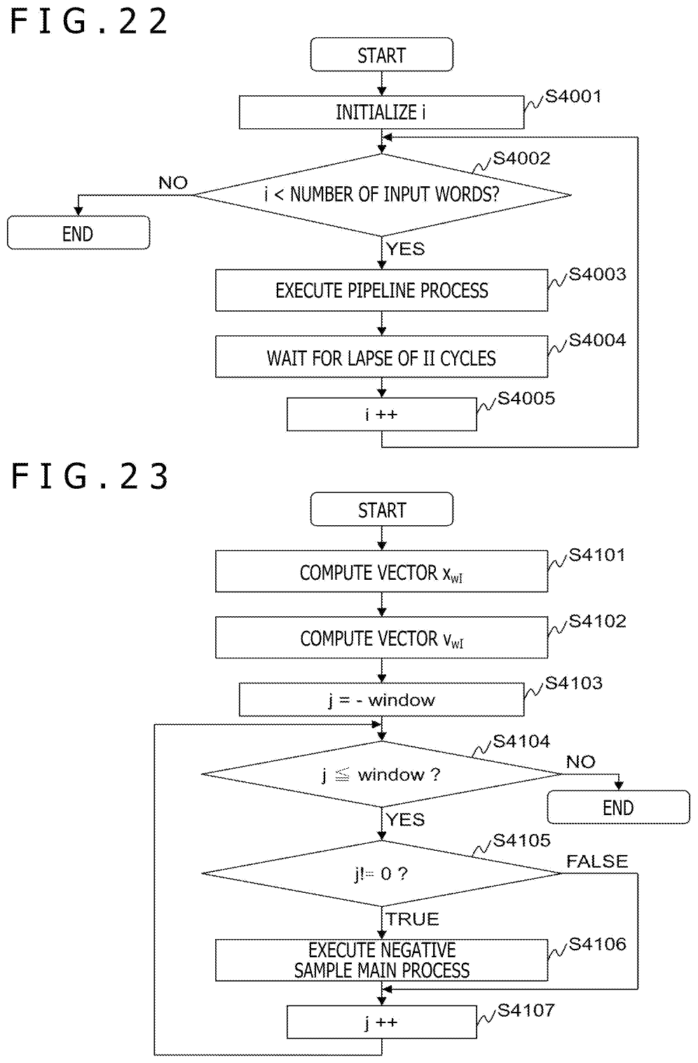

The positive sample calculation process in the second embodiment is identical to that in the first embodiment. The negative sample calculation process in the second embodiment is partially different from that in the first embodiment. FIG. 22 is a flowchart for explaining one example of the negative sample calculation process executed by the accelerator 102 in the second embodiment.

The accelerator 102 initializes the variable i (Step S4001). Specifically, the variable i is set to 0.

Next, the accelerator 102 decides whether or not the variable i is smaller than the number of input words (Step S4002).

In a case where the variable i is equal to or larger than the number of input words, the accelerator 102 ends the negative sample calculation process.

In a case where the variable i is smaller than the number of input words, the accelerator 102 executes a pipeline process at an optional circuit on the FPGA 1900 (Step S4003). Details of the pipeline process are explained with reference to FIG. 23.

After a lapse of II cycles after the execution of the pipeline process is started, the accelerator 102 sets the variable i to a value obtained by adding 1 to the variable i (Step S4004), and then returns to Step S4002.

With a process like the one described above, the pipeline parallel processing can be executed in the FPGA 1900.

FIG. 22 has been explained thus far.

FIG. 23 is a flowchart for explaining one example of the pipeline process executed by the accelerator 102 in the second embodiment.

The processes of Step S4101 to Step S4107 are identical to the processes of Step S3103 to Step S3110. It should be noted however that in a case where, at Step S4101, the variable j is larger than window, the accelerator 102 ends the pipeline process.

Similar to the first embodiment, the second embodiment also allows for determination of the number of negative samples for generating a model with high inference accuracy in a practical length of time required for learning processes.

### Third Embodiment

The third embodiment is different from the first embodiment in that, other than the CPU 101, a multi-core CPU is used as the accelerator 102. In the following, mainly, differences of the third embodiment from the first embodiment are explained.

The configuration of the computer system 10 in the third embodiment is identical to that in the first embodiment. In the third embodiment, the multi-core CPU is used as the accelerator 102. Examples of the multi-core CPU include Intel XeonPhi (Intel is a registered trademark; the same applies hereinafter), for example. In this case, the CPU 101 and the accelerator 102 are connected with each other via a communication path such as Intel QuickPath InterConnect.

The number-of-negative-samples computation process in the third embodiment is performed in the same process flow as in the first embodiment, but is different from its counterpart in terms of the method of computing the maximum value of the number of negative samples. First, after the configuration file 111 in the third embodiment is explained, the method of computing the maximum value of the number of negative samples in the third embodiment is explained.

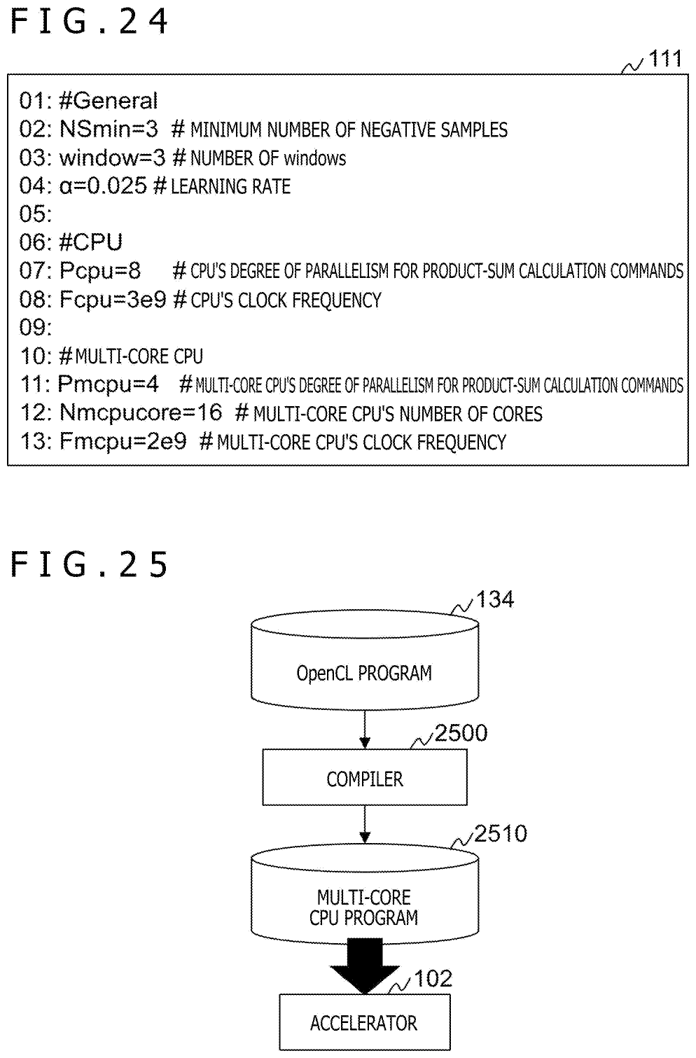

FIG. 24 is a figure illustrating one example of the configuration file 111 in the third embodiment.

In FIG. 24, leftmost numbers indicate line numbers, and character strings that follow “#” indicate comments.

The second line to the fifth line define the values of parameters that do not depend on hardware. Specifically, NSmin in the second line is a parameter indicating the minimum value of the number of negative samples, Nma in the third line is a parameter indicating the number of product-sum calculations in the positive sample calculation, window in the fourth line is a parameter indicating the number of windows, and α in the fifth line is a parameter indicating a learning rate. In FIG. 24, NSmin is set to 3, Nma is set to 5e12, window is set to 3, and α is set to 0.025.

The eighth line and the ninth line define values of parameters related to the CPU 101. Pcpu in the eighth line is a parameter indicating the degree of parallelism for product-sum calculation commands of the CPU 101, and Fcpu in the ninth line is a parameter indicating the clock frequency of the CPU 101. In FIG. 24, Pcpu is set to 8, and Fcpu is set to 3e9. Note that Fcpu is expressed in Hz.

The eleventh line to the thirteenth line define values of parameters related to the multi-core CPU. Pmcpu in the eleventh line is a parameter indicating the degree of parallelism for product-sum calculation commands of the multi-core CPU, Nmcpucore in the twelfth line is a parameter indicating the number of calculation cores of the multi-core CPU, and Fmcpu in the thirteenth line is a parameter indicating the clock frequency of the multi-core CPU. In FIG. 24, Pmcpu is set to 4, Nmcpucore is set to 16, and Fmcpu is set to 2e9. Note that Fmcpu is expressed in Hz.

Note that the pipeline start interval II can be checked in an output of a compiler for FPGA, or the like.

FIG. 24 has been explained thus far.

Next, the method of computing the maximum value of the number of negative samples in the third embodiment is explained. In the third embodiment, the neural network learning section 110 computes the maximum value of the number of negative samples on the basis of Formula (24) at Step S1002.

$$\begin{matrix}[ Formula 24 ] & \\ \begin{matrix}Number of \\ negative samples\end{matrix} = \frac{Pmcpu \times Nmcpucore \times Fmcpu}{Pcpu \times Fcpu} & ( 24 )\end{matrix}$$

Formula (24) is a formula that is derived in a case where it is hypothesized that the execution time of the positive sample sequential process performed by the CPU 101 indicated by Formula (6), and the execution time of the negative sample parallel processing performed by the multi-core CPU indicated by Formula (25) are equal to each other.

$$\begin{matrix}[ Formula 25 ] & \\ Nma \times \frac{Number of negative samples}{\frac{Pmcpu \times Fmcpu}{Nmcpucore}} & ( 25 )\end{matrix}$$

Note that in a case where the value computed on the basis of Formula (24) is not an integer, the neural network learning section 110 converts the value to an integer by performing a process such as rounding off, rounding up or rounding down.

The array initialization process, the CPU transmission process, the thread generation process, the thread wait, the CPU reception process and the array addition process in the third embodiment are identical to those in the first embodiment.

Note that the compilation process for the OpenCL program 134 in the third embodiment is as follows. FIG. 25 is a figure for explaining the compilation process executed by the neural network learning section 110 in the third embodiment.

A compiler 2500 included in the program that realizes the neural network learning section 110 compiles the OpenCL program 134 to thereby convert the OpenCL program 134 into a multi-core CPU program 2510 that the multi-core CPU can execute.

The compiler 2500 is a compiler for multi-core CPU, and, for example, is a compiler described in “Intel, Intel SDK for OpenCL Applications, https://software.intel.com/en-us/opencl-sdk, [Date of Retrieval: Jun. 7, 2019].”

FIG. 25 has been explained thus far.

The positive sample calculation process in the third embodiment is identical to that in the first embodiment. The negative sample calculation process in the third embodiment is identical to that in the first embodiment. It should be noted however that, at Step S3101, the accelerator 102 sets the initial value of the variable i to a value computed by using Formula (26). In addition, at Step S3102, the accelerator 102 decides whether or not the variable i is smaller than the value of Formula (27).

$$\begin{matrix}[ Formula 26 ] & \\ \frac{Number of input words}{Ngpucore} \times Core number & ( 26 ) \\ [ Formula 27 ] & \\ \frac{Number of input words}{Ngpucore} \times ( Core number + 1 ) & ( 27 )\end{matrix}$$

Note that identification numbers which are integers in the range of 0 to (Nmcpucore-1) are allocated to calculation cores of the multi-core CPU.

Similar to the first embodiment, the third embodiment also allows for determination of the number of negative samples for generating a model with high inference accuracy in a practical length of time required for learning processes.

Note that the computer 100 may be a computer not including the accelerator 102, but including only the CPU 101 (multi-core CPU) having a plurality of calculation cores. In this case, the neural network learning section 110 causes at least one calculation core of the multi-core CPU to execute the positive sample calculation process, and at least one calculation core different from the calculation core that executes the positive sample calculation to execute the negative sample calculation process. In this case also, similar control can be realized.

Note that the present invention is not limited to the embodiments described above, but includes various modification examples. In addition, for example, configurations of the embodiments described above are explained in detail in order to explain the present invention in an easy-to-understand manner, and embodiments of the present invention are not necessarily limited to the ones including all the configurations that are explained. In addition, some of the configurations of each embodiment can additionally have other configurations, can be removed, or can be replaced with other configurations.

In addition, the configurations, functionalities, processing sections, processing means and the like described above may partially or entirely be realized by hardware by designing them in an integrated circuit, or by other means, for example. In addition, the present invention can be realized also by software program codes that realize the functionalities of embodiments. In this case, a storage medium having the program codes recorded thereon is provided to a computer, and a processor included in the computer reads out the program codes stored on the storage medium. In this case, the program codes themselves read out from the storage medium realize the functionalities of the embodiments mentioned before, and the program codes themselves or the storage medium having the program codes stored thereon forms the present invention. Examples of such a storage medium used for supplying the program codes include, for example, a flexible disk, a CD-ROM, a DVD-ROM, a hard disk, a solid state drive (SSD), an optical disk, a magneto-optical disk, a CD-R, a magnetic tape, a non-volatile memory card, a ROM and the like.

In addition, the program codes that realize the functionalities described in the present embodiment can be implemented by a wide range of programs or script languages such as an assembler, C/C++, Perl, Shell, PHP, Python or Java (registered trademark), for example.

Furthermore, the software program codes that realize the functionalities of the embodiments may be distributed via a network, and thereby stored on a hard disk of a computer, a storage means such as a memory or a storage medium such as a compact disc read only memory (CD-RW) or a compact disc-recordable (CD-R), and a processor included in the computer may read out and execute the program codes stored on the storage means or the storage medium.

Control lines and information lines that are considered as being necessary for explanation are illustrated in the embodiments mentioned above, and all the control lines and information lines that are necessary for realizing products are not necessarily illustrated. All the configurations may be interconnected.

What is claimed is:

1. A computer system that executes a learning process for generating a model for event prediction by using a negative sampling method, the computer system comprising:
at least one computer having a plurality of calculation cores and a storage apparatus; and
a learning section that executes the learning process by using a plurality of pieces of training data, wherein
the learning section
acquires performance information indicating performance characteristics of the calculation cores that execute a positive sample calculation, and the calculation cores that execute a negative sample calculation;
computes a maximum value of the number of negative samples in the negative sample calculation on a basis of the performance information;
determines the number of the negative samples on a basis of the maximum value; and
generates the model by causing at least one of the calculation cores to execute the positive sample calculation using a predetermined number of pieces of training data to serve as positive samples in the training data, and by causing at least one of the calculation cores to execute the negative sample calculation using the determined number of the negative samples randomly selected from the training data.

2. The computer system according to claim 1, wherein,
as the maximum value of the number of pieces of data of the negative samples in the negative sample calculation, the learning section computes a number of pieces of data of the negative samples, the number minimizing a difference between processing time required for the positive sample calculation and processing time required for the negative sample calculation.

3. The computer system according to claim 1, wherein
the performance information is included in configuration information storing a parameter for controlling the learning process.

4. The computer system according to claim 1, wherein
the at least one computer includes a first calculating apparatus including at least one of the calculation cores, and a second calculating apparatus including at least one of the calculation cores, and
the learning section causes the first calculating apparatus to execute the positive sample calculation, and causes the second calculating apparatus to execute the negative sample calculation.

5. The computer system according to claim 4, wherein
the first calculating apparatus is a CPU, and
the second calculating apparatus is any of a GPU-mounted board, a FPGA-mounted board, and a CPU.

6. The computer system according to claim 1, further comprising:
a CPU including the plurality of calculation cores, wherein
the learning section causes the at least one calculation core included in the CPU to execute the positive sample calculation, and causes the at least one calculation core that is included in the CPU, and different from the at least one calculation core allocated to the positive sample calculation to execute the negative sample calculation.

7. The computer system according to claim 1, wherein
a minimum value of the number of the negative samples is set for the computer system, and
the learning section corrects the determined number of the negative samples to the minimum value of the number of the negative samples in a case where the determined number of the negative samples is smaller than the minimum value of the number of the negative samples.

8. A learning method that is executed by a computer system, and is for generating a model for event prediction by using a negative sampling method,
the computer system including at least one computer that has a plurality of calculation cores and has a storage apparatus, and a learning section that executes a learning process for generating the model by using a plurality of pieces of training data, the learning method comprising:
acquiring, by the learning section, performance information indicating performance characteristics of the calculation cores that execute a positive sample calculation and the calculation cores that execute a negative sample calculation;
computing, by the learning section, a maximum value of the number of negative samples in the negative sample calculation on a basis of the performance information;
determining, by the learning section, the number of the negative samples on a basis of the maximum value; and
generating, by the learning section, the model by causing at least one of the calculation cores to execute the positive sample calculation using a predetermined number of pieces of training data to serve as positive samples in the training data, and by causing at least one of the calculation cores to execute the negative sample calculation using the determined number of the negative samples randomly selected from the training data.

9. The learning method according to claim 8, wherein
the second step includes a step of computing, by the learning section and as the maximum value of the number of pieces of data of the negative samples in the negative sample calculation, a number of pieces of data of the negative samples, the number minimizing a difference between processing time required for the positive sample calculation and processing time required for the negative sample calculation.

10. The learning method according to claim 8, wherein
the performance information is included in configuration information storing a parameter for controlling the learning process.

11. The learning method according to claim 8, wherein
the at least one computer has a first calculating apparatus including at least one of the calculation cores and a second calculating apparatus including at least one of the calculation cores, and
the fourth step includes
a step of causing, by the learning section, the first calculating apparatus to execute the positive sample calculation, and
a step of causing, by the learning section, the second calculating apparatus to execute the negative sample calculation.

12. The learning method according to claim 11, wherein
the first calculating apparatus is a CPU, and
the second calculating apparatus is any of a GPU-mounted board, a FPGA-mounted board, and a CPU.

13. The learning method according to claim 8, wherein
the at least one computer includes a CPU including the plurality of calculation cores, and
the fourth step includes
a step of causing, by the learning section, the at least one calculation core included in the CPU to execute the positive sample calculation, and
a step of causing, by the learning section, the at least one calculation core that is included in the CPU and different from the at least one calculation core allocated to the positive sample calculation to execute the negative sample calculation.

14. The learning method according to claim 8, wherein
a minimum value of the number of the negative samples is set for the computer system, and
the third step includes a step of correcting, by the learning section, the determined number of the negative samples to the minimum value of the number of the negative samples in a case where the determined number of the negative samples is smaller than the minimum value of the number of the negative samples.

15. A program to be executed by a computer that executes a learning process for generating a model for event prediction by using a negative sampling method,
the computer having a plurality of calculation cores and a storage apparatus, the program comprising:
acquiring performance information indicating performance characteristics of the calculation cores that execute a positive sample calculation and the calculation cores that execute a negative sample calculation;
computing a maximum value of the number of negative samples in the negative sample calculation on a basis of the performance information;
determining the number of the negative samples on a basis of the maximum value; and
generating the model by causing at least one of the calculation cores to execute the positive sample calculation using a predetermined number of pieces of training data to serve as positive samples in the training data, and by causing at least one of the calculation cores to execute the negative sample calculation using the determined number of the negative samples randomly selected from the training data.
